(19) United States
(12) Patent Application Publication
(10) Pub. No.: US 2008/0117933 A1
(43) Pub. Date: May 22, 2008

(54) INTERNET BROADCASTING

(75) Inventors: John Castiglione, Del Mar, CA (US); Jason Sunstein, San Diego, CA (US)

Correspondence Address: WILSON SONSINI GOODRICH & ROSATI, 650 PAGE MILL ROAD, PALO ALTO, CA, 94304-1050, US

(73) Assignee: uBROADCAST, INC., San Diego, CA (US)

(21) Appl. No.: 11/937,745

(22) Filed: Nov. 9, 2007

Related U.S. Application Data
(60) Provisional application No. 60/865,382, filed on Nov. 10, 2006.

(51) Int. Cl. H04H 20/28

(52) U.S. Cl. 370/487

(57) ABSTRACT

An Internet broadcasting system is provided. The system comprises hardware and software for providing Internet broadcasting to an audience comprising one or more listeners. The system provides broadcast resources for the broadcaster to improve host information, program content and listener satisfaction. Particular broadcast resources provided include instant messaging software, voice over Internet protocol (VOIP) software, call management software, whiteboard software, live polling software, broadcast notes, chat room software, sound effects, and integrated email software. Also provided are methods of conducting an online poll, methods of advertising on the Internet and methods of providing Internet broadcast service to an audience.

This application claims priority under 35 U.S.C. § 119(e) from U.S. provisional patent application 60/865,382, filed Nov. 10, 2006, which is incorporated by reference herein in its entirety.

### BACKGROUND OF THE INVENTION

Radio broadcasting, especially on a national or international level, is a multi-billion dollar per year industry. Traditionally, radio broadcasting has been provided by transmission of a radio frequency carrier wave through space. The carrier wave is modulated at the source to encode a audio signal into the carrier wave. Two common forms of modulation are amplitude modulation (AM) and frequency modulation (FM). Radio receivers operated by individuals capture, demodulate and amplify the audio signal and reproduce it through a speaker.

More recent evolution of radio broadcasting has taken advantage of digital communication. As with AM and FM, a carrier signal is modulated. However, instead of impressing an analog signal on a carrier wave, the audio signal is first digitized via an analog to digital converter. The resulting digital signal is then impressed upon the carrier signal, which is then amplified and fed via an antenna into the surrounding space. A digital receiver having an antenna then receives the signal, amplifies it, demodulates it to extract the digital signal, then converts the digital signal to analog audio, which it then amplifies and plays through a speaker. Because digital radio transmits essentially a series of 1's and 0's, the signal to noise ratio for digital radio can be much higher than that available with AM or even FM.

With the birth of the Internet, it became possible to send audio signal from point to point over the Internet. The principle of voice over Internet protocol (VOIP) is conceptually simple. A audio signal is converted to a digital signal, much as it is in the case of digital radio. Then the digitized voice signal is sent from one computer to another. The second computer receives the digitized voice data, converts it back to an analog signal, amplifies the analog signal and plays it on a speaker. In its simplest form, VOIP permits point-to-point telephony using existing Internet network infrastructure.

Internet radio provides digitized audio signal to multiple listeners. Internet radio comes in two flavors: On demand and Live. In the case of On Demand, digitized (and generally compressed) audio files are stored on a server with some sort of index system, which allows a listener to select a broadcast to hear. Once selected, the digitized audio files are sent to the listener's computer where they are converted to an analog signal, amplified and fed to a speaker or speaker system. In many cases, the audio files are sent as streaming media, meaning that they are stored in a buffer on the listener's computer and played live. When the listener disconnects from the server, however, the streaming files are deleted from the listener's computer. Because most of such files are compressed, the buffer can contain sufficient data that the audio stream appears to the listener to be uninterrupted.

Live Internet radio is somewhat more complex, in that it requires a dedicated server to receive digitized audio signal from a broadcaster and then present the same signal in real time to multiple listeners. In practice, the broadcaster stores the digitized audio signal in a buffer on the broadcast service. The listener then chooses the broadcaster's signal from an index; and the broadcast provider provides the buffered signal to multiple listeners via separate Internet ports. This signal is received by the listeners' computers, is converted to analog, amplified and played over the listeners' speakers.

Traditional radio broadcasting is an expensive endeavor, requiring a large capital expenditure for production equipment (e.g. microphones, earphones, media players, telephones and mixers), transmission equipment (transmitters and antennas) and infrastructure (sales and marketing departments, music licensing, etc.) Moreover, traditional radio broadcasting is a government-regulated oligopoly with all the bureaucratic implications of such governance. Broadcast content is regulated to the extent that the government watches to ensure that minimal levels of public decency are maintained on the airwaves. Broadcast availability is limited by the bandwidth requirements of broadcast radio, the narrow range of frequencies relegated to broadcast radio, the practical limitations of broadcast distance and power requirements, and the inevitable overlap in signal coverage between radio markets. Thus governmental bodies ensure that a limited number of authorized broadcasters operate in a general locale, under strict limitations on broadcast power and frequency. This limitation on broadcast spectrum has the predictable result of increasing access costs due to restrictions on access availability.

While Internet radio has been available, it still suffers drawbacks that need to be addressed. In particular, currently available Internet radio suffers from a lack of real time feedback mechanisms. In particular, current applications of Internet radio require broadcasters to supply their own infrastructure elements, such as separate telephone, email and production hardware. Moreover, current Internet radio applications are limited in their ability to present visual information to listeners in real time. There is thus a need for an Internet broadcasting application and concomitant methods of broadcasting that provide one or more of these functions to the broadcaster, preferably in a single visual package that is easy to access and use.

The present invention meets the foregoing needs and provides related advantages as well.

### SUMMARY OF THE INVENTION

The present invention meets the foregoing needs and provides related advantages by providing a method of providing an Internet broadcast signal to an audience, comprising: (a) providing to a broadcaster broadcast software, said broadcast software including a broadcast client and one or more broadcast resource clients selected from the group consisting of: (i) instant messaging software; (ii) voice over Internet protocol (VOIP) telephone software; (iii) call management software; (iii) whiteboard software; (iv) live polling software; (v) broadcast notes; (vi) chat room software; (vii) sound effects; and (viii) integrated email software; (b) receiving a broadcast signal from the broadcaster; (c) receiving signal from said at least one broadcast resource client; and (d) providing the broadcast signal and said at least one broadcast resource to the audience.

In some embodiments, the invention provides a method of providing an interactive Internet broadcasting platform comprising: (a) providing a broadcasting application component to a plurality of broadcasters; (b) providing a player application software component to a plurality of listeners; and (c) providing a media server system. The method allows for interaction between one or more of said plurality of broadcasters and one or more of said plurality of listeners via said broadcasting application components and said player application software components. In some embodiments, the method of conducting an interactive Internet broadcasting platform further comprises providing an administrative server. In some embodiments, the method further comprises charging at least one of said plurality of broadcasters a fee for said broadcasting application component. In some specific embodiments, the fee includes a setup fee and a monthly maintenance fee. In some embodiments, the method further comprises charging at least one of said plurality of listeners a fee for said player application software component. In some specific embodiments, the interaction between one or more of said plurality of broadcasters and one or more of said plurality of listeners is in real-time. In particular embodiments, the interaction occurs in a form selected from the group consisting of the Internet, an electronic mail, a voice over internet protocol (VoIP), a text message, or combinations thereof. In some embodiments, the broadcasting application component comprises broadcasting application software comprising: (i) a setup application; (ii) a codec selection application; (iii) an audio input support application; (iv) an effects board application; (v) a connections list application; and (vi) an automatic update application. In some particular embodiments, the broadcasting application software further comprises software applications selected from the group consisting of: (i) a play list builder application; (ii) a white board application; (iii) a polling application; (iv) a messaging application; or (v) a combination thereof. In some specific embodiments, the broadcasting application software is in programming language portable C# code. In some embodiments, the player application software component comprises: (i) a setup application; (ii) a direct launch application; (iii) a directory list application; and (iv) a flash advertising application. In some specific embodiments, the player application software component further comprises: (v) an automatic update application. In some embodiments of the invention, the player application software component is in programming language C++. In some specific embodiments, the player application software component is in programming language MacOSX. In some embodiments, the media server system is the uBroadcast Media Server. Other media servers may also be used; the person of skill in the art will be familiar with other media servers that may be adapted to operate within the parameters of the present invention. In some embodiments, the administrative server comprises: (i) a broadcast setup operation; (ii) a broadcasting system reporting operation; and (iii) an advertising entry operation. In some embodiments, the broadcasting application component is initiated by a method comprising: (i) one or more of a plurality of broadcasters signing up for the broadcasting platform online; (ii) one or more of a plurality of broadcasters downloading broadcast application software; (iii) one or more of a plurality of broadcasters selecting one or more broadcast times for a broadcast show; (iv) one or more of a plurality of broadcasters selecting one or more formats for said broadcast show; and (v) one or more of a plurality of broadcasters initiating said broadcast show at the selected one or more broadcast times of (c). In some specific embodiments, the broadcasting application component is initiated by a method further comprising: (a1) one or more of a plurality of broadcasters obtaining broadcast application hardware. In some specific embodiments, steps (a)-(e) are initiated via the Internet. In some embodiments, one or more of a plurality of broadcasters of step (b) is charged a fee for downloading the broadcast application software. In some specific embodiments, the fee includes a setup fee and a monthly maintenance fee. In some specific embodiments, the formats are selected from the group consisting of cooking, education, entertainment, finance, health, local events, music, news, real estate, religion special interest, sports, travel, weather, or combinations thereof. In some embodiments, the step of providing a player application software component to a plurality of listeners further comprises: (i) one or more of said plurality of listeners accessing said interactive Internet broadcasting platform; and (ii) said one or more of said plurality of listeners downloading said player application software. In some currently preferred embodiments, the (a) (b) are performed, at least in part, via the Internet. In some specific embodiments, the interactive Internet broadcasting platform is a talk radio broadcasting platform.

Thus, the present invention provides a method of providing listener interaction with an interactive internet radio broadcast, said method comprising: (a) a listener accessing an interactive Internet broadcasting platform; (b) said Internet broadcasting platform providing said listener with a menu of one or more pre-determined broadcasting formats representing the subject matter of a broadcast show; (c) said listener selecting a broadcasting format from said one or more pre-determined categories representing the subject matter of a broadcast show; (d) said Internet broadcasting platform providing said listener a menu of one or more broadcast shows categorized as the subject matter selected in step (c); (e) said listener selecting a broadcast show from the menu of step (d); and (f) said listener interacting with the broadcast show selected in step (e). In some embodiments, the steps (a)-(f) are in real-time. In some embodiments, the steps (a)-(f) occur in a form selected from the group consisting of the Internet, an electronic mail, a voice over internet protocol (VoIP), a text message, or combinations thereof. In some specific embodiments, the interactive Internet broadcasting platform is a talk radio broadcasting platform.

In some embodiments, the invention provides a method of providing an interactive Internet broadcasting platform to a plurality of broadcasters wherein one or more of said broadcasters can select a broadcasting format from one or more pre-determined categories representing the subject matter of said broadcaster's broadcast show. In some embodiments, the advertising entry system comprises one or more advertisements for display to one or more of a plurality of listeners. In other embodiments, one or more advertisements are displayed through said player application software component. In still further embodiments, the advertisements are displayed on one or more internet radio broadcast shows based upon the subject matter of said one or more broadcast shows. In some specific embodiments, the interactive Internet broadcasting platform is a talk radio broadcasting platform.

In some embodiments, the invention provides a storage device having stored thereon an ordered set of instructions for a broadcast application which, when executed by a computer, performs a method comprising the steps of: (a) a broadcaster signing up for the broadcasting platform online; (b) said broadcaster downloading broadcast application software; (c) said broadcaster selecting one or more broadcast times for a broadcast show; (d) said broadcaster selecting one or more formats for said broadcast show; and (e) said broadcaster initiating said broadcast show at the selected one or more broadcast times of (c).

In some embodiments, the invention provides a storage device having stored thereon an ordered set of instructions for a player application which, when executed by a computer, performs a method comprising the steps of: (a) a listener accessing said broadcast platform; (b) the listener downloading player application software; and (c) the listener initiating an interactive broadcast by accessing a broadcast show using said player software of (b).

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 depicts main window of a broadcast client application according to the present invention.

FIG. 2 shows a device selection screen of a broadcast client according to the present invention.

FIG. 3 depicts an account setting page for a broadcast client according to the present invention.

FIG. 4 shows a public profile page for a broadcast client according to the present invention.

FIG. 5 depicts a show type selection screen for a broadcast client of the present invention.

FIG. 6 depicts a window that presents broadcaster resources to the broadcaster. The broadcaster resources include such things as email resources, show material and advertisers. The depicted tab, email resources, provides email templates for the broadcaster, which allows the broadcaster to keep in touch with the broadcaster's listening audience.

FIG. 7 shows a play list accessible through a tab of a broadcast client according to the present invention.

FIG. 8 shows a sound effects list accessible through a tab of a broadcast client according to the present invention.

FIG. 9 is a screen shot of broadcast notes accessible through a tab of a broadcasting client according to the present invention.

FIG. 10 depicts another screen shot of broadcast notes according to the present invention.

FIG. 11 is a screen shot of a poll question creator, which is part of a broadcasting client according to the present invention.

FIG. 12 depicts a white board, which is part of a broadcasting client according to the present invention.

FIG. 13 depicts a log in screen for a broadcast listening client according to the present invention.

FIG. 14 depicts a menu for selecting a program according to the present invention.

FIG. 15 is a screen shot of a listener client for use with a method according to the present invention.

FIG. 16 depicts a screen shot of an alternate station manager client for use in a method according to the present invention.

### DETAILED DESCRIPTION OF THE INVENTION

Thus, embodiments of the invention provide a method of providing an Internet broadcast signal to an audience, comprising: (a) providing to a broadcaster broadcast software, said broadcast software including a broadcast client and one or more broadcast resource applications selected from the group consisting of: (i) instant messaging software; (ii) voice over Internet protocol (VOIP) software; (iii) call management software; (iv) whiteboard software; (v) live polling software; (vi) broadcast notes; (vii) chat room software; (viii) sound effects; and (ix) integrated email software; (b) receiving a broadcast signal from the broadcaster; (c) receiving signal from said at least one broadcast resource signal; and (d) providing the broadcast signal and said at least one broadcast resource signal to the audience. In some embodiments, the broadcast client and said broadcast resource clients are available to the broadcaster in a single web view. In some embodiments, the broadcast resources are available to the broadcaster by means of tabbed windows. In some embodiments, the broadcast client software further provides one or more broadcast functions selected from the group consisting of: a mixer, a play list, a sound effects list and a device manager. In some embodiments, the broadcast signal is provided to the listener in streaming format. In some embodiments, the broadcast resources further include real time current listener counts, broadcast time or power ratings. In some embodiments, the two or more broadcast resource clients to the broadcaster. In some embodiments, the method further comprises providing three or more broadcast resource clients to the broadcaster. In some embodiments, the method further comprises providing four or more broadcast resource clients to the broadcaster. In some embodiments, the method comprises providing one, two, three, four, five, six, seven, eight or nine broadcast resource clients to the broadcaster. In some embodiments, each broadcast resource client is available to the broadcaster through a single page view. In some embodiments, each broadcast resource client is available to the broadcaster through by means of tabbed windows.

The invention further provides a method of conducting online polling, comprising: (a) receiving a broadcast feed from a broadcaster; (b) providing the broadcast feed to a plurality of broadcast recipients; (c) receiving from the broadcaster at least one poll question; (d) posing the poll question to at least a subset of the plurality of broadcast recipients; (e) receiving one or more poll replies from one or more members of said subset of said plurality of broadcast recipients; and (f) providing said poll replies to the broadcaster. In some embodiments, the poll replies are provided to the broadcaster in a graphical or tabular format. In some embodiments, the poll replies to at least a portion of said plurality of broadcast recipients.

The present invention provides a method of providing Internet broadcast service to a plurality of Internet broadcast listeners. In general, the term audience is used herein to indicate a group of listeners who have elected to listen to a particular broadcast. Thus, the invention provides a method of providing broadcast service to at least one broadcaster and an audience. This method comprises receiving a broadcast signal from the broadcaster and providing that broadcast signal to the audience. More specifically, the invention provides a method of providing a broadcast signal to an audience, comprising receiving broadcast signal from the broadcaster, and providing broadcast signal to the listeners. As an aid to matching listeners to broadcasters, the method can also include collecting indexing information (such as genre of radio show) from the broadcaster and providing that information to a plurality of potential listeners. The potential listeners can then select the broadcasts that they wish to enjoy and the broadcast service can then send them the broadcast signals that they have selected. In the present invention, the broadcaster is capable of taking advantage of one or more broadcast resources which enhance broadcaster convenience, program quality and ultimately listener satisfaction. In particular embodiments, the methods of the invention provide the broadcaster with one or more broadcast resource clients, which send additional broadcast resource signal to a server, which then transmits the broadcast resource signal to listeners, who are then able to take advantage of these broadcast resources. In some preferred embodiments, the broadcast signal is provided to the Internet radio listeners in a streaming format, so that each listener enjoys the broadcast in real time.

The invention includes providing to the broadcaster a computer application (broadcast client) designed to aid the broadcaster in providing the broadcast signal to the listeners. The broadcaster may be an individual (e.g. a program host) or a team (e.g. a program host and a producer). The broadcast client is an application program designed to send broadcast signal (e.g. digitized audio signal) over a network such as the Internet to a broadcast server, which may be a dedicated server, having a sufficient number of ports to support multiple listeners. The broadcast client can also include broadcast production aids, such as on-board mixer, sound effects and play lists. The invention also includes providing to the broadcaster one or more additional application programs that are designed to enhance broadcast quality. Collectively these additional application programs are referred to herein as broadcast resource applications. Although these applications may be distributed independently, they are advantageously integrated with the broadcast client, and in the currently preferred embodiments, can be accessed from within the broadcast client in a single web view. This may be accomplished by presenting broadcast client views in one portion of a the web view or window while presenting the other broadcast resources in neighboring windows. Where multiple resources are bundled with the broadcast client, a system of tabbed windows can be presented, allowing the broadcaster to access the broadcast client and the broadcast resource applications easily from a single web view.

Thus, in order to provide enhanced communication between the broadcaster and the listeners, the present invention provides a palette of broadcast resources, which enhance feedback between the host and the listeners. These broadcast resources include one or more means of communicating with the audience in addition to the broadcast signal. In some embodiments, the broadcast resources include one or more additional means of communicating with the audience selected from the group: (i) instant messaging software; (ii) voice over Internet protocol (VOIP) telephone software; (iii) call management software; (iv) whiteboard software; (v) live polling software; (vi) broadcast notes; (vii) chat room software; and (viii) integrated email software. In specific embodiments said broadcast software and said broadcast resources are accessible to the broadcaster via a single integrated page view. In some more specific embodiments, the additional broadcast resources include two, three, four, five, six, seven or eight members of the foregoing group: (i) instant messaging software; (ii) voice over Internet protocol (VOIP) telephone software; (iii) call management software; (iv) whiteboard software; (v) live polling software; (vi) broadcast notes; (vii) chat room software; and (viii) integrated email software. In some specific embodiments, the broadcast resources are all accessible to the broadcaster via a single page view.

Traditional talk radio benefits from interplay between talk radio hosts and their callers. To this end, the average traditional talk radio show makes use of a bank of telephone lines, which is under control of a producer who mixes the telephone line signal into the transmission feed, allowing callers to be heard by the host and the audience simultaneously. The host or producer is thus able to select from a number of telephone callers, mixing their telephone signals or dropping their signals out of the broadcast transmission as desired. In order to facilitate such functionality, in some embodiments the present invention provides integrated VOIP telephone service, whereby one or more callers can place telephone calls to the broadcaster, who can then assign one or more callers to a queue. The broadcaster (either the host or a producer) may then select callers from the queue, mixing their telephone signal into the broadcast stream and dropping them out of the broadcast stream as desired. In some embodiments, the queue is controlled by the host. In some particular embodiments, the VOIP application and the queue are accessible, along with the broadcast software, to the host via a single web view. Thus, in some embodiments, the present invention provides not only the VOIP telephone service, but also the integrated software necessary to allow the broadcaster to manage telephone calls.

In some embodiments, additional telephone lines may be connected to the broadcaster's computer, allowing the broadcaster to control access to these telephone lines as well. The additional telephone lines may be land lines, wireless lines or a mixture of both. In some particular embodiments, the telephone lines can provide 1-800 service to listeners. The additional telephone lines may be connected to the broadcaster's computer e.g. via a specially adapted sound card. In an alternative, the additional telephone lines may be connected to a server, e.g. through an intranet or the Internet. The server may perform the function of converting audio signal to digital signal and vice versa. The server may also perform the call management function; however in currently preferred embodiments of the invention, call management is performed by a call management client that is located on the broadcaster's computer. In some currently preferred embodiments of the invention, the call management software (whether as a client or on a server) is available to the broadcaster on the same web view as the other broadcast software.

Two-way communication over the Internet is often carried out by instant messaging. With instant messaging, two users may communicate peer-to-peer after having been connected to one another using the resources of an instant messaging server. The server holds contact lists for all the users registered to use that particular instant messaging service. When a user logs on to the server using a locally resident instant messaging client, the server collects the user's IP address and port number, and provides this information to instant messaging clients belonging to other users who have added the user to their contact lists (also sometimes called buddy lists). A user may choose a name from the contact list and establish a peer-to-peer connection with another user. This method of communication can be adapted for use in Internet broadcasting, in that the broadcaster can subscribe to an instant messaging service and provide the broadcaster's contact name to the audience. Audience members who register with the instant messaging service can then communicate directly with the broadcaster in a manner analogous to any other instant messaging service. In some embodiments, the instant messaging service would be provided by the broadcast provider, e.g. on a specialized server. In some particular embodiments, the broadcast software resident on the broadcaster's computer may include an integrated instant messaging client as part of a bundle of broadcaster resources. In some specific embodiments of the invention, the broadcaster's instant messaging client may be integrated into the broadcast software; and in some preferred embodiments, the broadcaster's instant messaging client may be visible and accessible through the same page view as the broadcast software. In some embodiments, rather than providing user IP addresses and ports to each client accessing the instant messaging system, the server may mediate the communication, thereby providing a firewall between the users (listeners) and the broadcaster. In other words, the server may maintain a connection with the broadcaster's instant messaging client and each user's instant messaging client. Using this information, the instant messaging server may then receive communication from a client (e.g. one belonging to a listener) and provide it to another client (e.g. one belonging to the broadcaster) without divulging either party's IP address and port to the other party. This alternative would provide the benefit of providing some security buffer between the broadcaster and the listeners. (For example, the instant messaging server could be equipped with a firewall to exclude communication from certain listeners, to automatically scan messages for potential viruses, and to provide a confidential IP address to the broadcaster). It would also allow the dedicated instant messaging server to manage instant messaging traffic, thereby ensuring that the instant messaging bandwidth does not exceed the broadcaster's capacity. In some particular embodiments, the broadcast software resident on the broadcaster's computer will include an integrated instant messaging client as part of a bundle of broadcaster resources. In some specific embodiments of the invention, the broadcaster's instant messaging client will be integrated into the broadcast software; and in some preferred embodiments, the broadcaster's instant messaging client will be visible and accessible through the same page view as the broadcast software. In any case, the precise manner of operation of the instant messaging system (whether true peer-to-peer instant messaging or server-mediated instant messaging) will have the same look and feel to the broadcaster and the listeners. In some embodiments, the broadcaster will be given the choice between peer-to-peer and server mediated instant messaging; and in some specific embodiments, the broadcaster may be permitted to switch from one to the other in real time, depending upon the load on the broadcaster's bandwidth. Thus, the methods of the present invention include, in some embodiments, providing instant messaging service to the broadcaster and the broadcaster's listeners. In some embodiments, when a listener selects a particular broadcast program from the index, an instant messaging link is automatically established (peer-to-peer or server-mediated) between the listener and the broadcaster. In other embodiments, either the broadcaster, the listener or both must elect to establish the link before instant messaging service is provided to them.

Traditional radio may make use of a variety of audio signal sources for transmission. Generally, audio signals from multiple sources may be provided to a mixer, which allows a producer or program host to combine two or more audio signals, to switch between audio signals, or a combination of both. The mixer also allows the broadcaster to select the volume level for each audio signal in a broadcast transmission. This process of combining and switching audio signals is called “mixing.” The mixer combines inputs, outputs, pots and other control devices. Digital processing on a computer permits mixing to be accomplished digitally, using a computer-resident digital mixer, which combines digital signals in a manner analogous to the manner in which analog signals are mixed in an analog mixer. In some embodiments, the present invention provides an audio signal mixer capable of controlling a plurality of inputs from various sources. For example, one input may be the host's microphone; another may be one or more telephone inputs from a VOIP line; another may be a link to a sound effects file; another may be a link to files containing quotations, interviews, other soundbites, external recording media (CDs, DVDs, hard drives, etc.).

One of the limitations of traditional radio is, of course, the lack of visual communication between the host and the listeners. In some cases, traditional talk radio hosts have resorted to simulcast, whereby a visual image is transmitted by television while audio signal is transmitted via traditional AM or FM radio. Aside from the difficulty of establishing simulcast, and the concomitant expense thereof, other limitations of this approach include its relative inflexibility: the broadcaster must possess both audio and television transmission equipment, which must be synchronized, and each member of the audience must have access to both radio and television receivers. The Internet provides a useful medium for overcoming these limitations, as both audio and visual data may be transmitted over the same transmission lines and provided to the listener simultaneously. Thus, some embodiments of the invention, there is provided as a broadcast resource whiteboard software, which permits the broadcaster to draw pictures using a whiteboard broadcast client. This client allows the broadcaster to draw a picture, e.g. a graph, line drawing, etc., and transmit it to a server, which then provides access to the whiteboard content via the Internet. In some embodiments, the whiteboard software may also include the ability to cut and paste images, links, text or other matter onto the white board. Such images may include hyperlinked objects, such as links to audio or video provided by others. Thus, the broadcaster may enhance the listener's experience by providing visual stimuli in addition to audio. In some embodiments, the whiteboard software and the broadcast software are included in the same software bundle; and in particularly preferred embodiments, access to the whiteboard software is provided to the broadcaster in the same web view as the broadcast software and, if applicable, other broadcast resources. Thus, in some embodiments the method of the invention includes providing whiteboard broadcast service, which entails receiving whiteboard data from the broadcaster and providing it to listeners, who are able to view the whiteboard using a whiteboard viewing client. The whiteboard viewing client may be either a standalone or integrated client residing on the listener's computer. Thus, in certain embodiments, the method includes providing to the listener a whiteboard viewing client, which is adapted to receive whiteboard data from a server and display it for the listener.

Radio listeners often share a variety of backgrounds and attitudes in common. Traditional radio broadcasters often use informal or formal polling to obtain listener feedback and provoke listener interest. Various polling services exist, which provide results of formal polls to broadcasters, who then may use the poll results as fodder for monolog or discussion. One limitation to traditional polling is that there is a time lag between the time when poll data are collected and the time when the broadcaster receives the polling results. Another limitation is that traditional formal polling is not limited to a particular listening community and may not provide the host with an adequate picture of the listening audience, and thus may not adequately prepare the host for communication with the audience. To address these drawbacks, traditional radio broadcasters may attempt to employ informal telephone polls to approximate a real time survey of their listening audience's views. However, there are limitations to this methodology as well. Constraints of time and resources may limit the number of telephone calls that may be received, the number of telephone calls actually taken, etc. The present invention provides a solution to this problem by providing to the broadcaster live polling software. In this method, the broadcaster devises a poll question using a polling client and distributes the poll question to the listening audience by transmitting the poll question to a poll server, which then transmits the poll to the listeners. Each listener may then respond to the poll using a poll response client. The poll response client transmits each poll response to the poll server, which then distributes the poll responses back to the broadcaster's polling client. (The poll response may also, in some embodiments, be returned peer-to-peer.) The broadcaster's polling client can then analyze the poll responses and display the responses for the broadcaster. Thus, in some embodiments, the question may be posed as a true or false question, a multiple choice question or a free form question. The listeners can then select from among the provided answers or type their responses into a dialog box, which in some embodiments closes upon sending the poll answer back to the broadcaster. The polling client software on the broadcaster's computer (or alternatively on a polling server) may tabulate the answers and provide them to the broadcaster in the form of a chart (e.g. a pie chart), a graph (e.g. a line or bar graph), a table or other visual means of depicting poll data. The broadcaster can then elect to present these data to the audience in whatever way seems appropriate, e.g. by placing a copy of the chart or graph on the aforementioned whiteboard. Thus, in some embodiments, the polling data may be provided graphically to the audience members. In some embodiments, the polling client is combined with the broadcast software in an integrated package. In some specific embodiments, the polling client is integrated with the broadcast software and is accessible to the broadcaster in the same web view.

Like other media, talk radio relies to at least some degree on carefully crafted illusions. One of those illusions is that the host possesses a type of limited omniscience, having available at a moment's recall manifold information on a variety of topics of interest to the host and the listening audience. While some talk radio hosts may possess voluminous recall capacity, most rely on a system of notes to provide one or more of the following: (1) program outlines; (2) data, statistics and facts; (3) quotes; (4) important dates; (5) links to commonly used websites; and (6) other notes. These notes may be included on typed sheets of paper, note cards, teleprompters, cue cards or other visual mnemonic devices. The present invention solves the problem of providing broadcast notes to the broadcaster by providing a broadcast notes system for the broadcaster. The broadcast notes system contains a collection of notes organized to provide the broadcaster with fingertip access to important facts, data, quotes, dates, etc. In some embodiments, the broadcast notes form a “stack” of “cards,” which are accessible to the broadcaster in real time during the broadcast. In particular embodiments, the card stack may be accessible from the same web view as the broadcast software. In some particular embodiments, the stack presents to the broadcaster the card on the top of the stack. Clicking on the top card in the stack then moves the top card to the bottom of the stack and advances the next card down to the top of the stack. In some embodiments, the broadcaster may provide hyperlinks to other cards in the stack, to files on the Internet or intranet, or both. In some embodiments, there is provided a means to back up through a stack, so a broadcaster need not advance all the way through the stack in order to go back to a previous broadcast note. The mnemonic devices may also include RSS (really simple syndication) links, whereby the host can access a variety of news sources simultaneously. Using RSS, the broadcaster can subscribe to one or more websites. The RSS client on the broadcaster's computer (or a server) has what is known as an aggregator that constantly checks for updates to any sites to which the broadcaster has subscribed. The RSS client then displays results of the aggregator's search on the broadcaster's computer. For instance, the RSS client may display the results as a list of hyperlinks, which the broadcaster may follow to the updated site. In some embodiments, the RSS client is included in the broadcaster's software package as a broadcast resource. In particular embodiments, the RSS client is integrated in the broadcast software; and in some currently preferred embodiments, the RSS software is available to the broadcaster along with the other broadcast software on a single web view. In some specific embodiments, the various mnemonic devices provided to the broadcaster are available as a stack of tabbed folders, each of which may be opened by the broadcaster from a single web view.

Broadcasters often mix a variety of audio signals into the broadcast stream, thereby adding variety and interest to their broadcast programs. In general, a producer will have access to a mixing board which is connected to one or more storage media, such as l.p., cassette, compact disk, digital video disk, reel-to-reel tape, solid state sampling devices, hard disk drives, etc., which record audio signal and provide it to the mixer on demand by the producer or host. Such audio signal may include music (such as so-called bumper music, which comprises short clips of popular music to fill time between commercial breaks and live broadcast), sound effects, pre-recorded interviews, celebrity quotes, etc. A given broadcast program may make use of a variety of pre-recorded audio and the broadcast host must have immediate access to each in order to ensure program flow and enjoyment. The present invention provides the broadcaster with a play list, which is a broadcast resource through which the program host may access any of a variety of pre-recorded audio files via a central application. In some embodiments, the play list application not only lists the various audio files available to the broadcast host for the specific program (or in general), but also receives the broadcaster's selection and automatically mixes it into the broadcast signal. In some other embodiments, the play list feeds into an onboard mixer, which then provides the broadcast transmission to the broadcast server. In some embodiments, the play list is integrated with other broadcast resources and/or the broadcast software. In particular embodiments, the play list is accessible to the program host in the same web view as the other broadcast software and broadcast resources.

Internet users often communicate using chat rooms. Unlike the related instant messaging applications, chat rooms are generally hosted on a central server. Communication within the chat room is visible to all users; and the mixture of conversations carried out in this milieu is often varied and stimulating. The present invention provides integrated chat room service to the broadcaster and the program listeners. In particular, some embodiments of the invention provide chat room clients to the broadcaster and at least one listener. Together the broadcaster and the listeners may be thought of as users; however the broadcaster will generally have chat room host capabilities, such as the capability to exclude certain users from the chat room, e.g. as a means of disciplining those who fail to follow basic chat room etiquette or specific chat room policies. The chat room is hosted on a chat room server, which mediates communication between the various users who are “in” the chat room. In some embodiments, the host may establish more than one chat room, e.g. for the discussion of multiple topics or for the management of large numbers of chat room users. In some embodiments, the chat room client is visible and available to the broadcaster in the same web view as the broadcast software. Likewise, the chat room software may be integrated with the listener client; and in some preferred embodiments may be accessible to the client through the same web view as the listener client.

As mentioned above, radio broadcasters often make use of sound effects and other audio signals during the course of broadcast programs to add variety and interest to their programs. Such sound effects are generally stored on a variety of media, such as tapes, hard drives, compact disks and solid state media (e.g. random access memory) to be accessed during the radio program and mixed into the broadcast stream by the host or an engineer. In some embodiments of the present invention, sound effects are provided, e.g. in a hyperlinked list of sound effects that is accessible to the broadcaster. In specific embodiments, the sound effects are accessible via an application that forms an integrated package with the broadcast software. In certain specific embodiments, the sound effects are accessible through the same web view as the broadcast software. In certain particular embodiments, the sound effects are accessible without resort to the mixer: i.e. the sound effects can be selected from a sound effects list and played immediately without having to connect them to an internal or external mixer.

In recent years, traditional radio broadcasters have begun to make use of electronic mail, or email, as a means of maintaining communication with their audiences. The use of electronic mail is known and will not be described herein in detail. In general, email with an email client, which is capable of communicating with an incoming mail server (POP3 or IMAP) and an outgoing mail server (SMTP). The incoming and outgoing mail servers are located on a server machine, which is generally remote from the email client. In some embodiments, the present invention provides a bundled broadcasting suite which includes broadcast software and broadcast resources including an email client. In particular embodiments, the email client is accessible from the same web view as the broadcast software.

Revenue generation on traditional radio is generally provided by sales of advertising. In general, traditional radio relies on pre-recorded or live advertisements. One limitation to such advertising is that such advertisements interrupt program flow. Another limitation is that such advertisements are generally limited to audio transmissions. Internet radio can overcome these limitations to some degree, in that both audio and visual data may be transmitted over the Internet. Thus, some embodiments of the invention provide a method of advertising in which a broadcaster or advertiser can add an audio, visual or audio-visual advertisement to a broadcast transmission. The advertisement is then played for the listener by the listener client. The advertisement may of course provide one or more hyperlinks to vendors from whom the advertised product or service may be acquired. The broadcaster may provide the advertisement to the listeners for the benefit of an advertiser, who may compensate the broadcaster on a per view, per click or per listener basis (to name only a few bases for advertising billing).

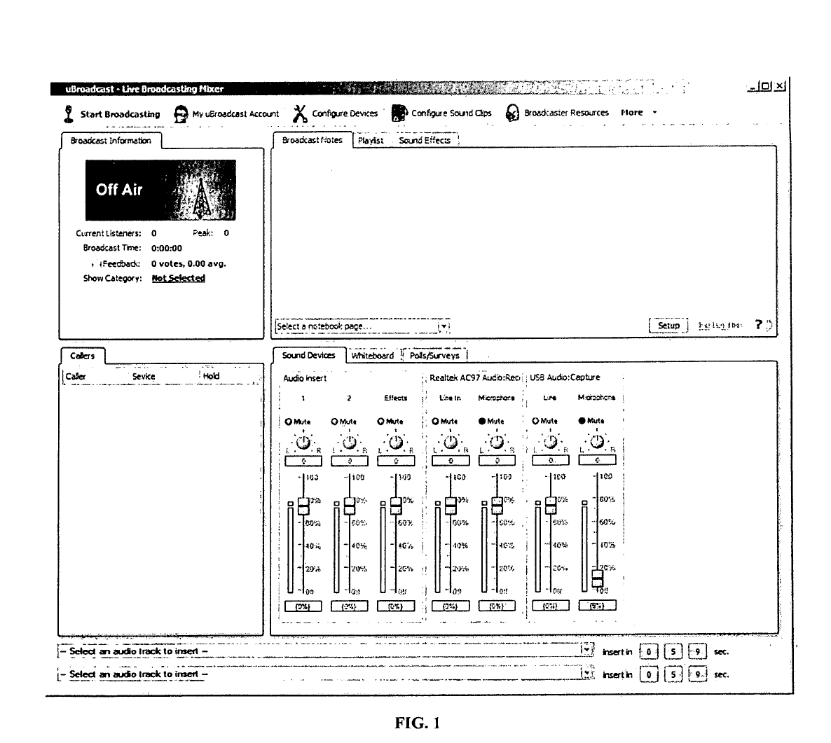

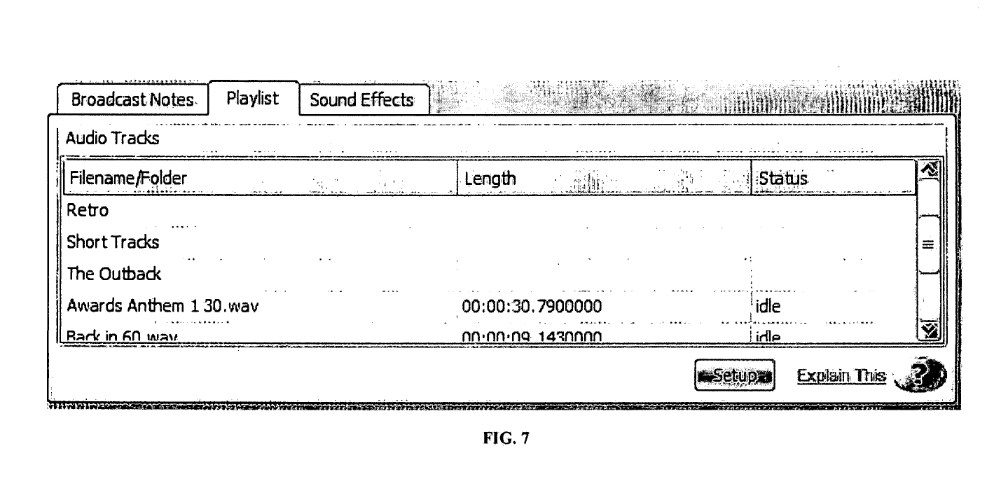

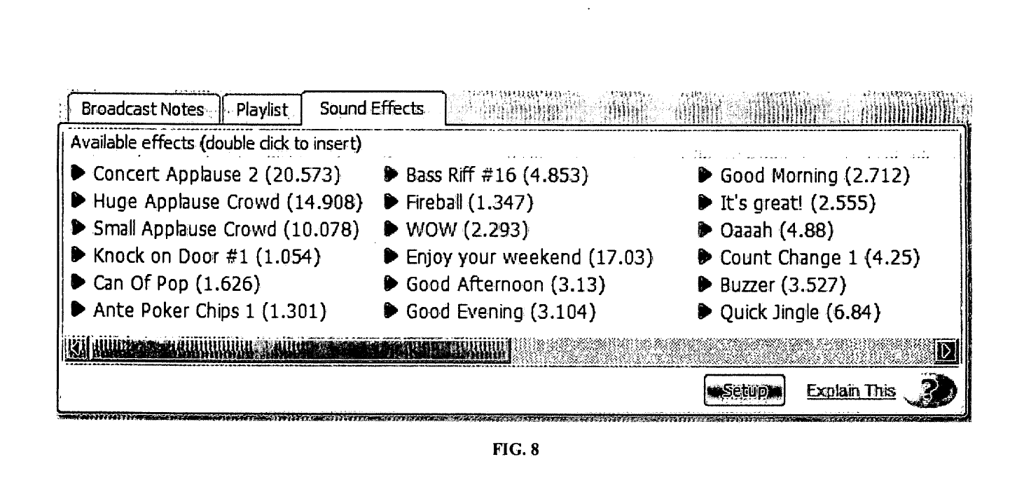

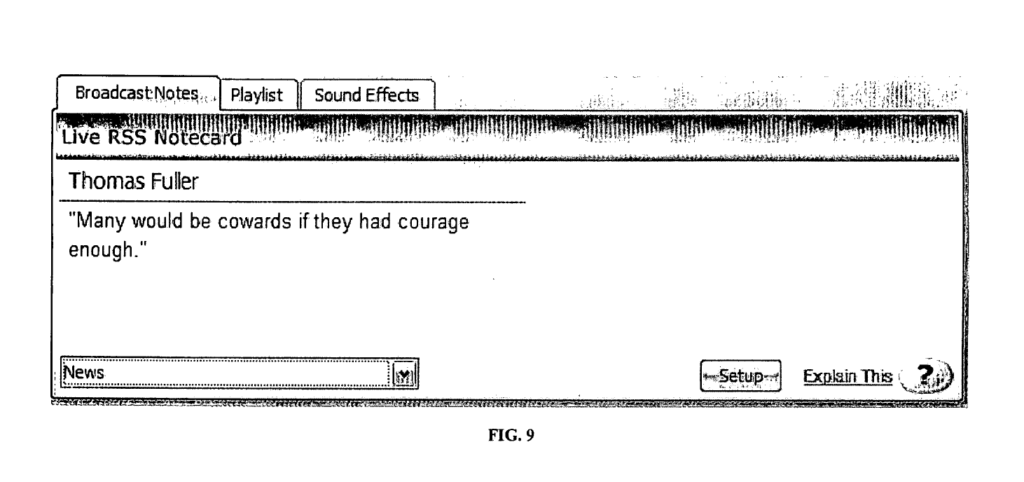

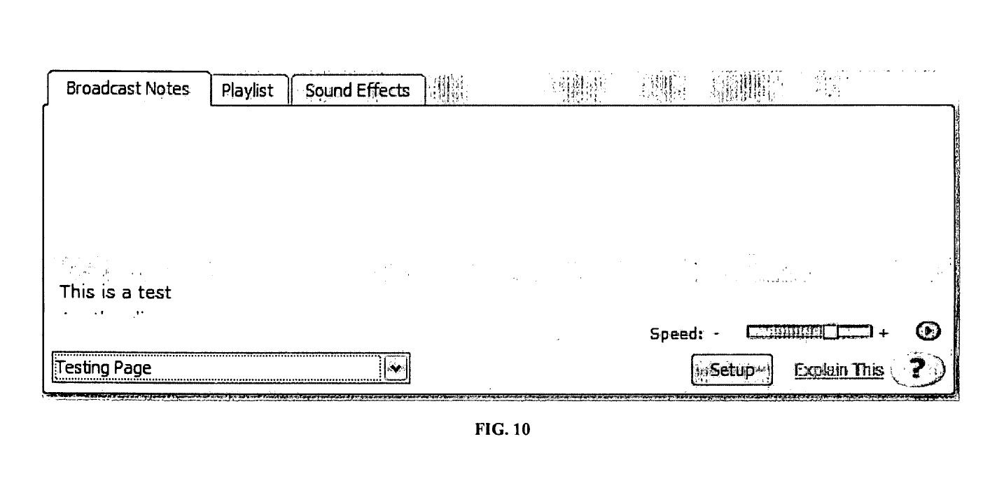

The invention will now be further described with reference to the drawings. FIG. 1 depicts a main application window for broadcasting software according to the present invention. The screen is divided into four sections, allowing easy viewing of all the important components of the broadcasting software. The top right section provides access via tabs to broadcast notes, a play list and sound effects. A play list is depicted in FIG. 7 and a sound effects list is depicted in FIG. 8. The broadcaster can view various broadcast notes, such as news from RSS clients, note card stacks, etc. by clicking the “broadcast notes” tab as depicted in FIG. 9, which shows a quote recorded in a broadcast notes page, and in FIG. 10, which shows another broadcast notes page. The broadcaster can easily switch between broadcast notes, play list and sound effects by clicking the tabs at the top of the top right section.

The bottom right section of the broadcast software view in FIG. 1 provides access to a mixer (tab entitled “sound devices,” a white board and a poll/survey client. The mixer is a computer based mixer device that provides the broadcaster with the ability to select between audio devices to mix into the broadcast stream. The mixer works in a manner analogous to hardware mixers. The broadcaster can select amongst audio feeds and select their volume levels by clicking and holding the various controls on the mixer using a mouse or other computer pointing device.

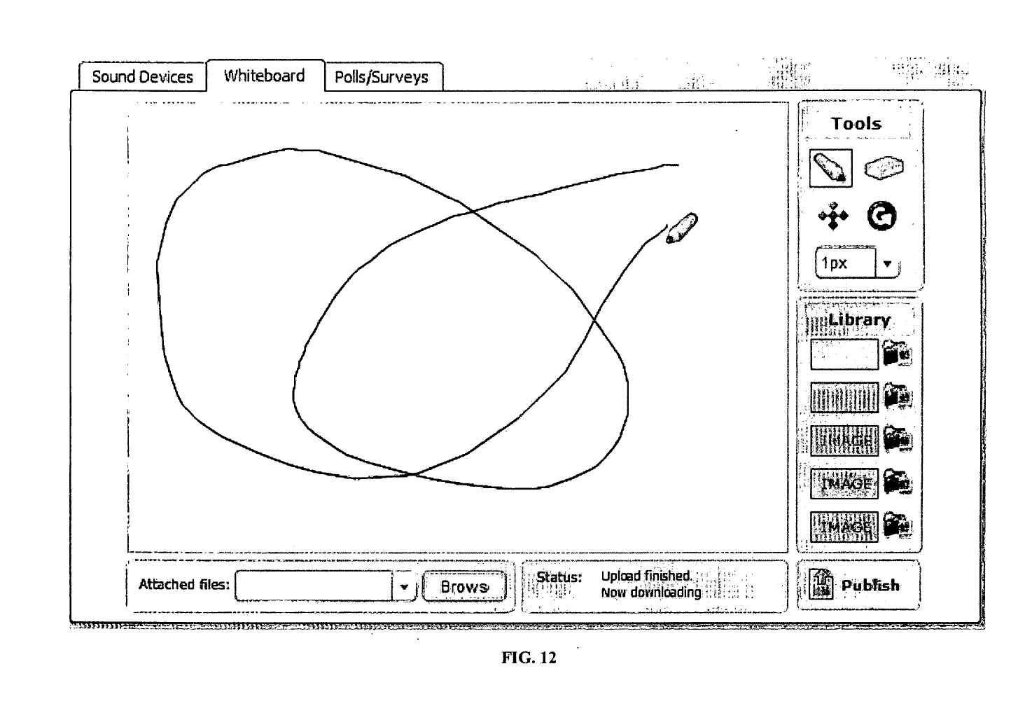

Clicking on the “whiteboard” tab brings up a white board as depicted in FIG. 12. The broadcaster may draw on the white board using drawing tools, such as a virtual pencil or paint brush. The broadcaster may also type on the white board using a text box tool. The broadcaster may also erase from the white board using an eraser tool. The broadcaster may copy and paste pictures, web links and other objects into the white board using standard cutting and pasting functions known in both Windows™ and Mac™ environments. The drawing tools may be selected from the tool bar on the right top corner of the white board. Various images may be selected from the library folders in the control bar at the right bottom corner of the white board. The broadcaster may also attach files using the attach files function on the control bar in the bottom left corner of the white board. The broadcaster may browse files on the broadcaster's own computer or on an attached file server using the browse button or may simply type the file name in the attached files box. Once the broadcaster is ready to publish the white board to the listening audience, the broadcaster can then press the “publish” button in the bottom right corner of the white board. The person of skill in the art will recognize that the tool, browse, attach files, image and other control buttons may be arranged anywhere on the white board view without deviating from the present invention. Also, additional drawing and editing tools may be included in the white board client; and such additional drawing and editing tools are contemplated as being within the scope of the present invention.

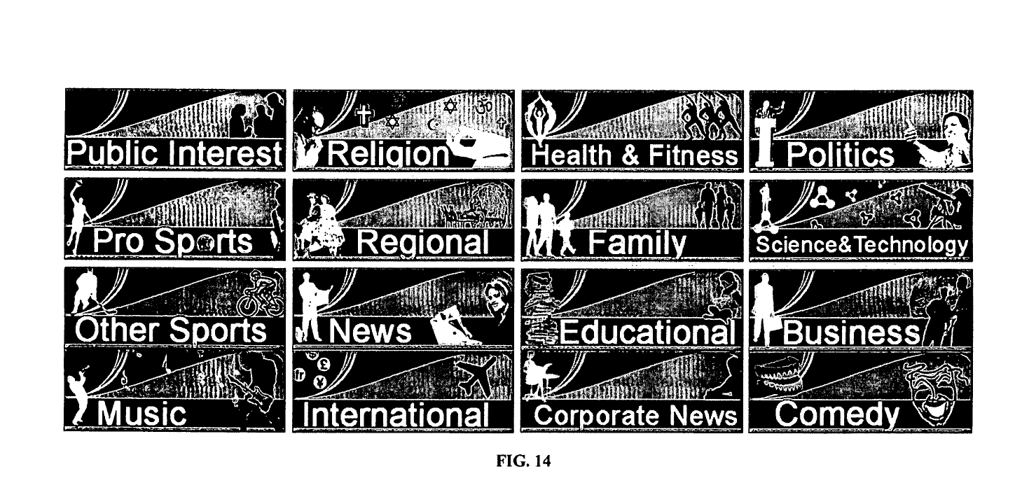

The broadcaster may view the status of the broadcaster's show using the broadcast information in the top left corner of the broadcast software view as depicted in FIG. 1. Clicking on the “start broadcasting” button in the top left corner of the broadcast software view will be reflected in the “broadcast information” section by the phrase “off air” (or the like) being replaced by the phrase “on air” (or the like). In addition, the antenna icon will be depicted as having waves radiating from the mast, thus visually indicating that the broadcaster's show is on the air. Just below the broadcast status icon, various status indicators are depicted. For example, in this view the broadcaster can easily see the number of current listeners, the peak number of listeners who have tuned in to the show during its duration, the elapsed broadcast time, feedback from the polling question, etc. The broadcast information section also shows the show category, which is one of a plurality of show categories that listeners may choose when selecting a show. FIG. 14 depicts a show selection page that is visible to listeners who are choosing which show to listen to. The broadcaster picks one of the broad categories of show in which to list the broadcaster's show, and when a listener selects one of the icons from the page depicted in FIG. 14 the listener is directed to an index page on which the broadcaster's show is listed, along with its broadcast times, show title, etc. The listener can then select the broadcaster's show.

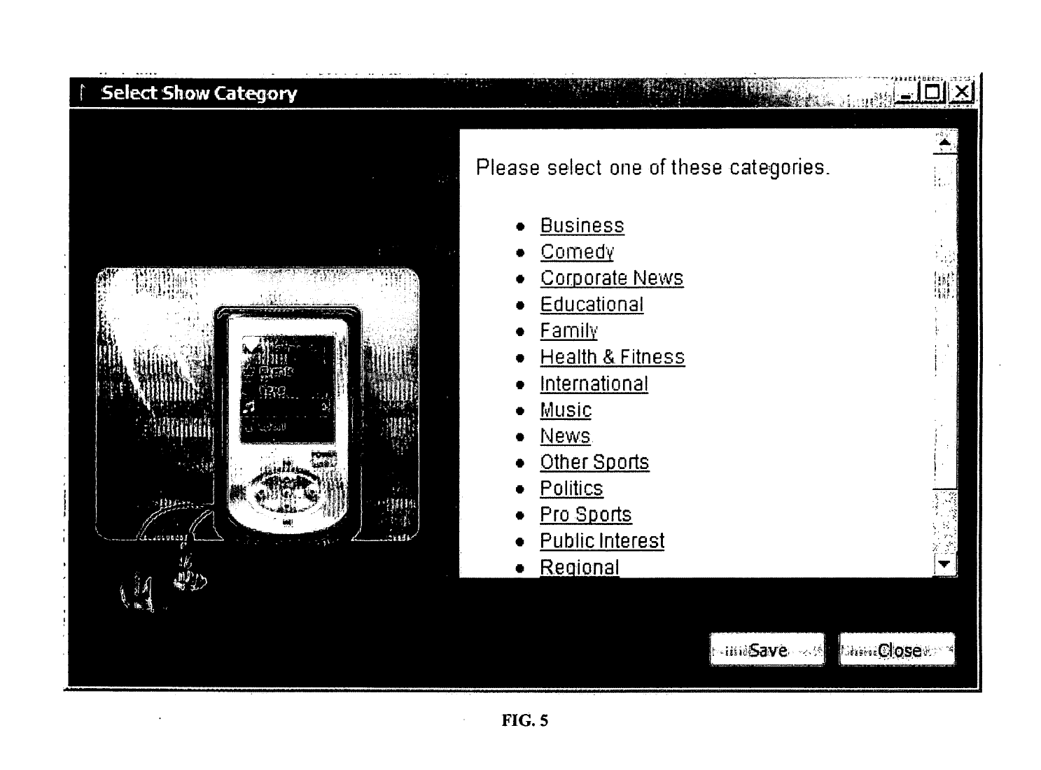

The broadcaster may select a category for the show by clicking on the “not selected” link under the broadcast status icon and selecting one of the categories from the presented list, e.g. as depicted in FIG. 5. Once the show category has been selected and saved, the broadcaster's show will be categorized in the selected category and made available to listeners who choose that category from those available in FIG. 14.

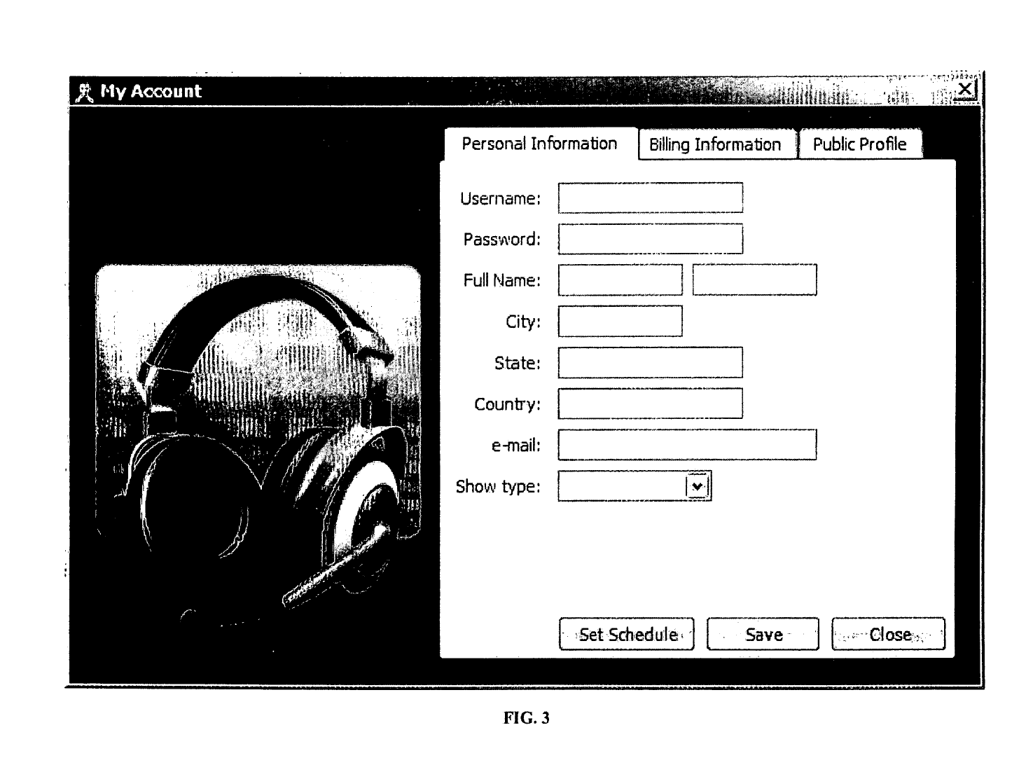

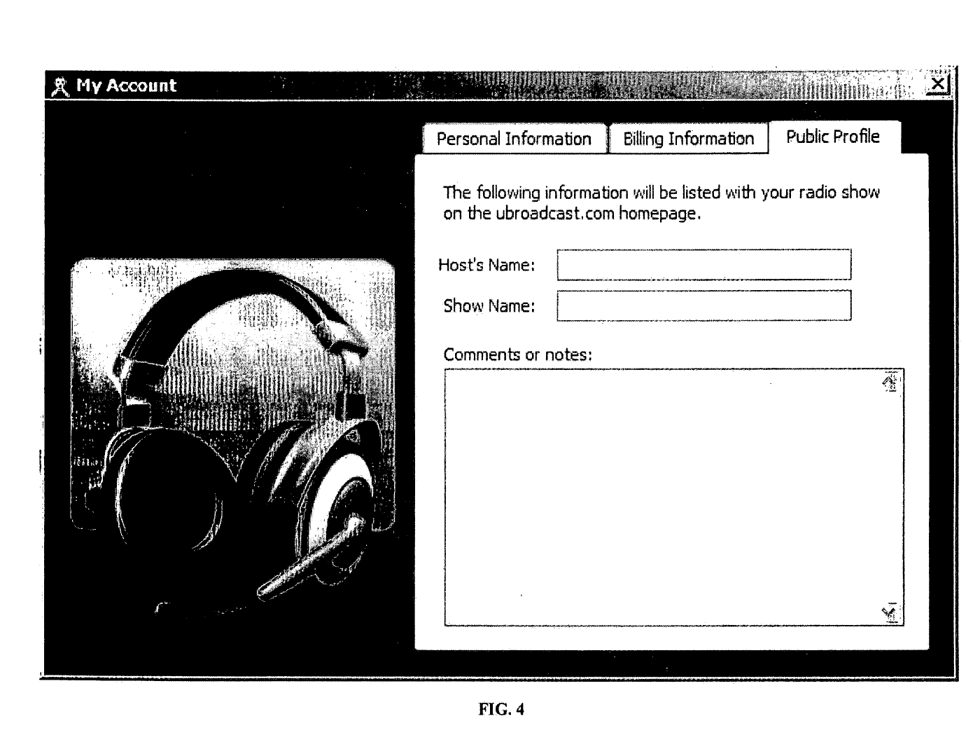

The broadcaster can also view broadcast account information by clicking on the account button on the top control bar as depicted in FIG. 1. (“My uBroadcast Account). This will take the broadcaster to a view that allows the broadcaster to provide personal information, billing information and a public profile (visible to listeners) by filling out the forms accessible by clicking the tabs at the top of the “My Account” page shown in FIG. 3. A public profile page, accessible by clicking the public profile tab depicted in FIG. 3, is visible in FIG. 4. The public profile page may include the host's name, the show name, comments or notes, etc. This information is made available to listeners in order to assist them in deciding whether or not to listen to the broadcaster's show.

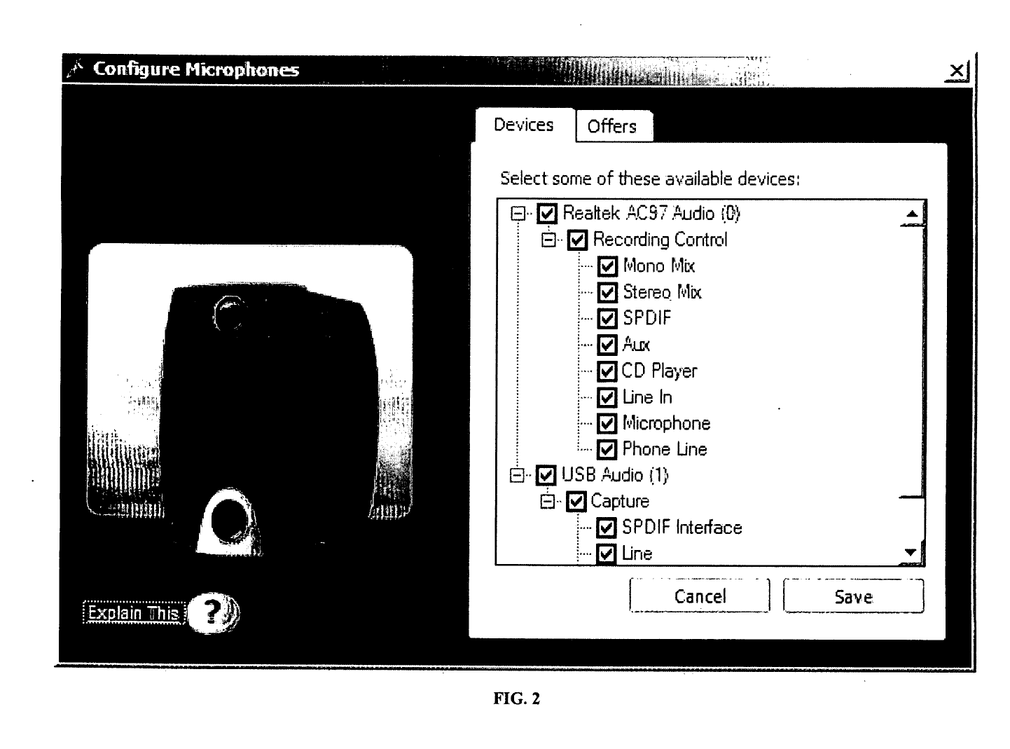

The broadcaster may configure input devices, such as microphones, headphones and other audio input and output devices, by clicking on the “configure devices” button at the top of the page depicted in FIG. 1. This will direct the broadcaster to a device configuration page, such as the one depicted in FIG. 2. By clicking on the various check boxes in the device window at the right of the page, the broadcaster can select and configure various input and output devices. This allows the broadcaster to connect a variety of audio input and output devices to the computer, optionally using a single sound card, and set the audio devices to work with the broadcaster's broadcast software without resort to external mixing boards, etc. Of course one of the audio input devices may be an external mixing board and such an external device can also be configured using the configuration device depicted in FIG. 2.

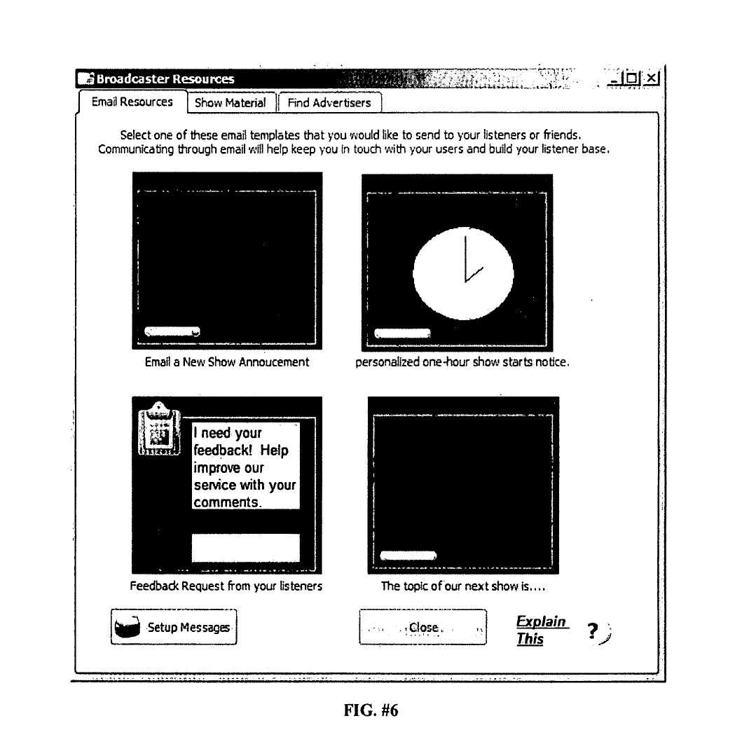

The broadcaster may access various broadcaster resources using the broadcaster resources button on the control bar at the top of the page depicted in FIG. 1. This will take the broadcaster to a broadcaster resources page, where the broadcaster can access, for example, an email client, show material, and a find advertisers client. The email resources client, depicted in FIG. 6, allows the broadcaster to keep in touch with registered listeners. The email resources include a new show announcement, a personalized one hour show starts announcement, a next show announcement and an email template. Thus, the email client allows the broadcaster to send any of a variety of messages to listeners or potential listeners, informing them of upcoming show themes and content.

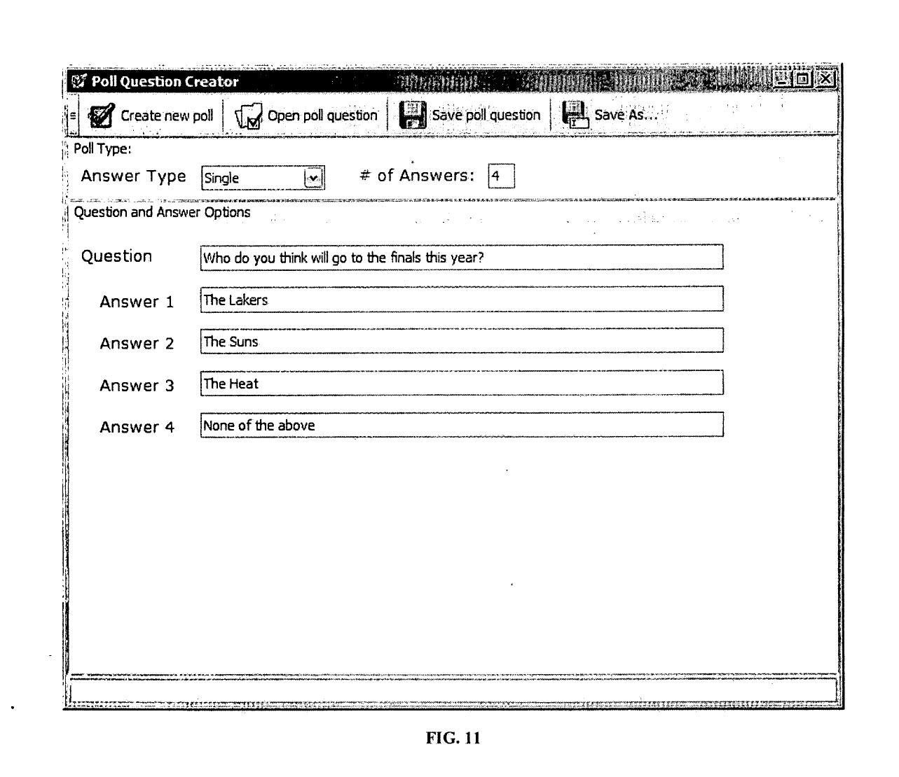

The broadcaster may access the polling client by clicking on the polls/surveys tab. This brings up the polling client as depicted in FIG. 11. The polling client allows the broadcaster to create poll questions by first selecting the type of answer (e.g. single answer multiple choice, or “single,” multiple answer multiple choice, or “multiple,” and “free form” answers for typed answers. The broadcaster then selects the number of answers to display. The broadcaster then types the question to be posed to listeners in the “Question” box and the answers in the boxes marked Answer 1, . . . Answer 4. The broadcaster may save the poll question by clicking on the “save poll question” icon on the control bar. The broadcaster may save a copy of the poll question using the “save as” icon on the control bar. The broadcaster can open a saved poll by clicking the “open poll question” icon on the control bar; and the broadcaster can create a new poll question using the “create new poll question” icon on the control bar.

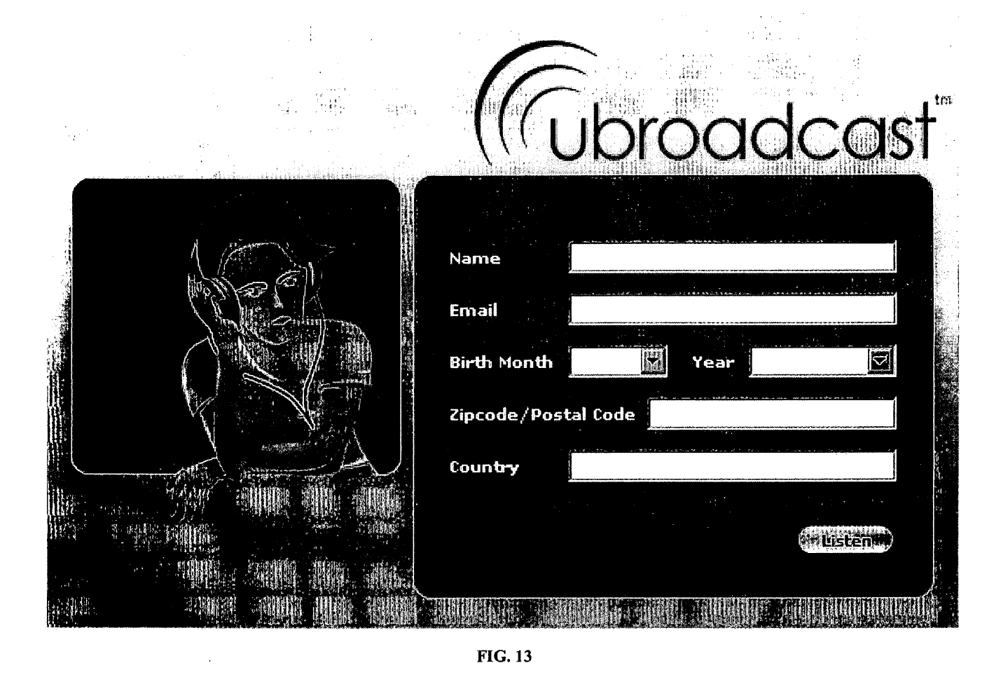

The current invention is simple for a listener to access. First, the listener calls up a listener registration page as depicted in FIG. 13. Once the listener is registered and signed in, the listener can then select from one of the categories as depicted in FIG. 14. This selection will redirect them to an index showing all the programs available under that category. The listener can then click on the desired show. The listener's broadcast player client then receives the broadcast signal from the broadcast server and plays the broadcast through the listener's sound card. In addition, the broadcast player client displays any visual data, such as white board, polling questions, etc. that the broadcaster may publish to the listeners and may respond as appropriate, e.g. to polling questions. Thus, the present invention provides an integrated listening and viewing environment for the listener. This environment is easy to use, while at the same time providing exceptional value to the listener and the broadcaster alike.

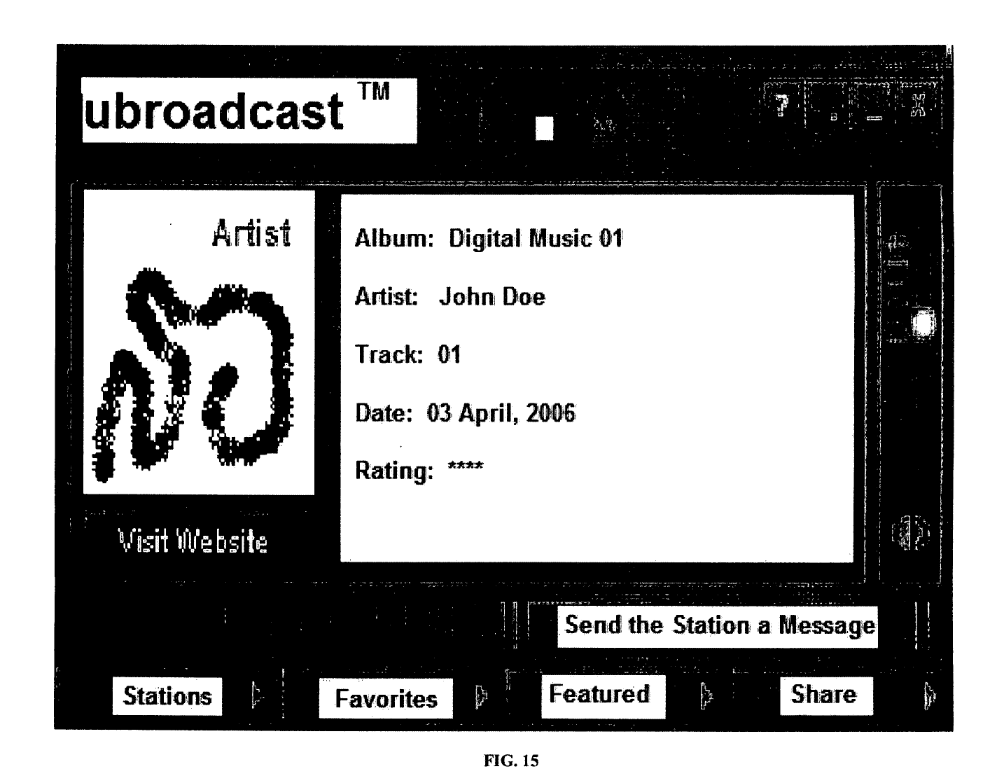

In some embodiments, the listener's player client displays a player window, such as that depicted in FIG. 15. In the depicted screen shot, the player window identifies the name of the broadcast host in the top left corner. In the depicted embodiments, the player window has controls for play, stop and fast forward, help, minimizing and closing the window, sound volume control as well as buttons for opening web pages, windows, popups or drop-down menus for selecting stations, favorite songs, featured songs, etc. It is also possible with this player window to select a button to send the broadcast station a message, e.g. by instant messaging or email.

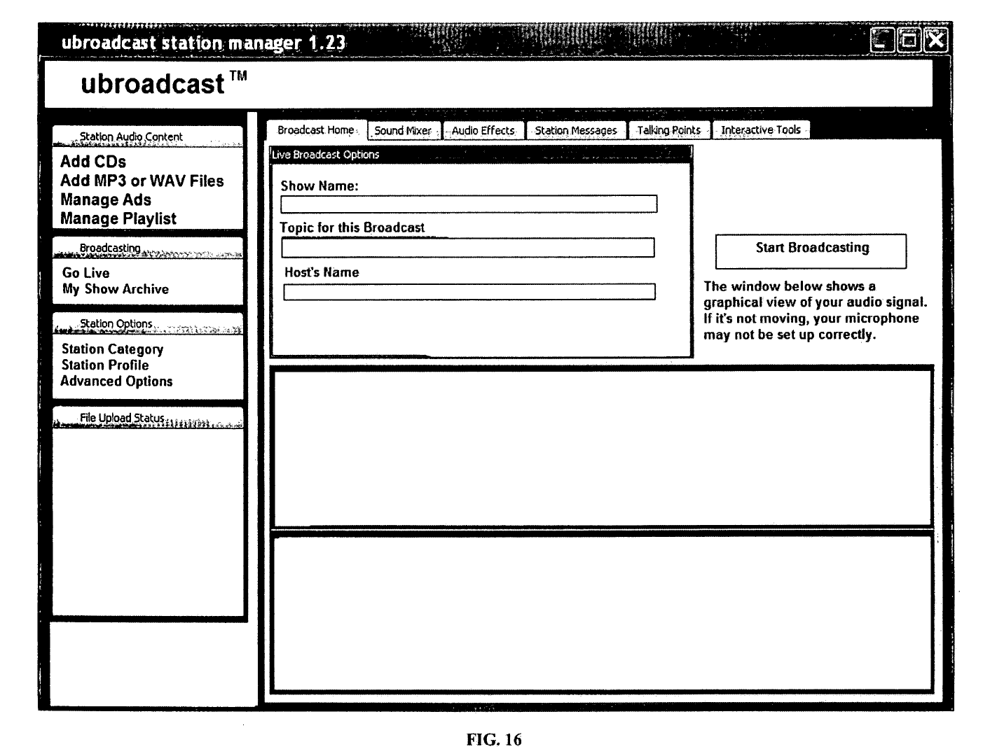

An alternative broadcast station manager page is depicted in FIG. 16. The left-most column allows the station manager to select station audio content, broadcasting mode, station options and file uploading. Station audio content may be chosen from any digital sound file, including CD or DVD, MP3, WAV or other digital format. The audio content may of course be selected from music, talk, advertising, etc.

The broadcaster may choose to broadcast live or to broadcast an archived show. The broadcaster may also manage the listing of the broadcast based upon show content. The broadcaster may for instance manage the station category, the station profile, and other options that may be listed under advanced options.

The tabs visible on the right hand side of the station manager of FIG. 16 allow the broadcaster to manage various aspects of the broadcast. As seen in the screen shot in FIG. 16, the tabs include a Broadcast Home tab, a Sound Mixer tab, an Audio Effects tab, a Station Messages tab, a Talking Points tab and an Interactive Tools tab.

The Broadcast Home tab allows the broadcaster to Enter a Show Name, a Show Topic and the Host's Name. The Host Name may, for example, be the name of a featured advertiser.

In some embodiments, the sound mixer tab may bring up a tab similar in design to that depicted in FIG. 1 (lower right quadrant). The audio effects may be similar in design to the sound effects tab depicted in FIG. 8. The Station Messages tab may link to an Instant Messenger, Email, Text-Message or other type of interactive messaging service. The Talking Points tab may be linked to a window similar to the Broadcast Notes tab depicted in FIG. 9. The interactive tools may include, for example, the white board as depicted in FIG. 12. Although the Station Manager page is depicted as having all of these tabs, the person of skill in the art will recognize that one or more of these tabs may be omitted, or additional tabs may be added, as desired.

While preferred embodiments of the present invention have been described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method of providing an Internet broadcast signal to an audience, comprising:
(a) providing to a broadcaster broadcast software, said broadcast software including a broadcast client and one or more broadcast resource applications selected from the group consisting of:
(i) instant messaging software;
(ii) voice over Internet protocol (VOIP) software;
(iii) call management software;
(iv) whiteboard software;
(v) live polling software;
(vi) broadcast notes;
(vii) chat room software;
(viii) sound effects; and
(ix) integrated email software;
(b) receiving a broadcast signal from the broadcaster;
(c) receiving signal from said at least one broadcast resource signal; and
(d) providing the broadcast signal and said at least one broadcast resource signal to the audience.

2. The method of claim 1, further comprising providing advertising to at least one listener in the audience.

3. The method of claim 1, wherein the broadcast client software further provides one or more broadcast functions selected from the group consisting of: a mixer, a play list, a sound effects list and a device manager.

4. The method of claim 1, wherein the broadcast signal is provided to the listener in streaming format.

5. The method of claim 1, wherein the broadcast resources further include real time current listener counts, broadcast time or power ratings.

6. The method of claim 1, comprising providing two or more broadcast resource clients to the broadcaster.

7. A method of providing broadcast Internet service to a broadcaster, comprising:
(a) providing a server adapted to receive broadcast content from a broadcaster and distribute the broadcast content to a plurality of broadcast recipients;
(b) providing a suite of broadcast support applications adapted to provide broadcast support, said broadcast support applications being selected from the group consisting of:
(i) instant messaging software;
(ii) voice over Internet protocol (VOIP) software;
(iii) call management software;
(iv) whiteboard software;
(v) live polling software;
(vi) broadcast notes;
(vii) chat room software;
(viii) sound effects; and
(ix) integrated email software;
(c) receiving broadcast content from a broadcaster;
(d) distributing the broadcast content to a plurality of broadcast recipients; and
(e) providing at least one of the following additional services to the broadcaster, the recipient or both:
(i) instant messaging;
(ii) voice over Internet protocol (VOIP);
(iii) whiteboard;
(iv) live polling;
(v) broadcast notes;
(vi) chat room hosting; and
(vii) integrated email software.

8. The method of claim 7, further comprising providing advertising to at least one listener in the audience.

9. The method of claim 7, wherein the broadcast client and said broadcast resource clients are available to the broadcaster in a single web view.

10. The method of claim 7, wherein the broadcast signal is provided to the listener in streaming format.

11. The method of claim 7, wherein the broadcast resources further include real time current listener counts, broadcast time or power ratings.

12. The method of claim 7, comprising providing two or more broadcast resource clients to the broadcaster.

13. A method of conducting online polling, comprising:
(a) receiving a broadcast feed from a broadcaster;
(b) providing the broadcast feed to a plurality of broadcast recipients;
(c) receiving from the broadcaster at least one poll question;
(d) posing the poll question to at least a subset of the plurality of broadcast recipients;
(e) receiving one or more poll replies from one or more members of said subset of said plurality of broadcast recipients; and
(f) providing said poll replies to the broadcaster.

14. The method of claim 1, comprising:
(a) receiving broadcaster registration information from at least one broadcaster;
(b) receiving a broadcast signal from said at least one broadcaster;
(c) receiving a request for access to the broadcast signal from each member of the audience; and
(d) providing access to the broadcast signal to the audience in real time.

15. The method of claim 1, comprising:
(a) receiving broadcaster registration information from a broadcaster;
(b) providing an index of broadcasts that lists said broadcaster information;
(c) providing access to said index to each of said plurality of listeners;
(d) receiving a broadcast choice corresponding to the broadcaster from each of a subset of said plurality of listeners, wherein said subset of said plurality of listeners makes up said audience; and
(e) providing real time access to the broadcast for each listener belonging to said audience.

16. A method of providing an interactive Internet broadcasting platform comprising:
(a) providing a broadcasting application component to a plurality of broadcasters;
(b) providing a player application software component to a plurality of listeners; and
(c) providing a media server system;
wherein said method allows for interaction between one or more of said plurality of broadcasters and one or more of said plurality of listeners via said broadcasting application components and said player application software components.

17. The method of claim 16, wherein said method of conducting an interactive Internet broadcasting platform further comprises:
(d) an administrative server.

18. The method of claim 17, wherein said administrative server comprises:
(i) a broadcast setup operation;
(ii) a broadcasting system reporting operation; and
(iii) an advertising entry operation.

19. The method of claim 16, wherein said broadcasting application component is initiated by a method comprising:
(a) one or more of a plurality of broadcasters signing up for the broadcasting platform online;
(b) said one or more of a plurality of broadcasters downloading broadcast application software;
(c) said one or more of a plurality of broadcasters selecting one or more broadcast times for a broadcast show;
(d) said one or more of a plurality of broadcasters selecting one or more formats for said broadcast show; and
(e) said one or more of a plurality of broadcasters initiating said broadcast show at the selected one or more broadcast times of (c).

20. The method of claim 20, said broadcasting application component is initiated by a method further comprising:
(f) said one or more of a plurality of broadcasters obtaining broadcast application hardware.

21. The method of claim 16, wherein said step of providing a player application software component to a plurality of listeners further comprises:
(a) one or more of said plurality of listeners accessing said interactive Internet broadcasting platform; and
(b) said one or more of said plurality of listeners downloading said player application software.

22. A method of providing an interactive Internet broadcasting platform to a plurality of broadcasters wherein one or more of said broadcasters can select a broadcasting format from one or more predetermined categories representing the subject matter of said broadcaster's broadcast show.

23. The method of claim 24, wherein said advertising entry system comprises one or more advertisements for display to one or more of a plurality of listeners.

24. A storage device having stored thereon an ordered set of instructions for a broadcast application which, when executed by a computer, performs a method comprising the steps of:
(a) a broadcaster signing up for the broadcasting platform online;
(b) said broadcaster downloading broadcast application software;
(c) said broadcaster selecting one or more broadcast times for a broadcast show;
(d) said broadcaster selecting one or more formats for said broadcast show; and
(e) said broadcaster initiating said broadcast show at the selected one or more broadcast times of (c).
